(19) United States
(12) Patent Application Publication
(10) Pub. No.: US 2020/0107536 A1
(43) Pub. Date: Apr. 9, 2020

(54) SYSTEM AND METHOD FOR APPLYING TREATING COMPOUNDS TO AGRICULTURAL PRODUCTS

(71) Applicant: Fruit Growers Supply Company, Sherman Oaks, CA (US)

(72) Inventor: David Michael SORENSON, Visalia, CA (US)

(21) Appl. No.: 16/595,213

(22) Filed: Oct. 7, 2019

Related U.S. Application Data
(60) Provisional application No. 62/742,070, filed on Oct. 5, 2018.

(51) Int. Cl. A01M 1/20; A01N 65/12; A01N 31/04; A01N 25/04

(52) U.S. Cl. CPC A01M 1/2033; A01N 25/04; A01N 31/04; A01N 65/12

(57) ABSTRACT

A fluid dispersion system and a fluid dispersion method are provided. The system includes a plurality of side walls defining a confined volume, an agricultural product receiving area configured to hold a volume of agricultural products, a first fogging fan orientated adjacent to the agricultural product receiving area, the first fogging fan having a fluid spraying system configured to spray a fluid compound at high pressure in front of the first fogging fan. The method includes placing an agricultural product between a plurality of fogging fans in an enclosed environment, spraying an insecticide compound into each of the plurality of fogging fans at high pressure.

### CROSS-REFERENCE TO RELATED APPLICATIONS

This application claims priority under 35 U.S.C. 119(e) to U.S. Provisional Patent Application No. 62/742,070, filed Oct. 5, 2018, the disclosure of which is incorporated herein by reference in its entirety as if set forth in full.

### BACKGROUND

### Field

The present disclosure relates to systems and methods for applying treating compounds to agricultural products, and more specifically systems and methods for applying vaporized liquid compounds to fruits, vegetables and livestock.

### Related Art

Fogging is often used to apply liquid compounds to agricultural products for a variety of purposes. For example, fogging may be used to apply disinfectants, fungicides, and insecticides. Previous fogging systems used fogger bottles that required air assistant, like venturi suction up to the compounds to spray it. Other related art systems have provided fans that just spray out in front of the fan blades. Still other related art systems relay on different commercial grade foggers to generate or disperse fog.

Further, in related art research initially only used sanitizers sprayed from systems that use air assist bottles or the fans. Then, combination of fungicides or fungicides and other additives such as organic acids or oxidizers have been added. For example, related art processes may use potentially carcinogenic formaldehyde for sanitizing, but these systems can be difficult or hazardous to operate as the formaldehyde would be turned on and the operator would need to quickly exit the room while avoiding formaldehyde spray. Additionally, the efficacy was moderate to lower for these related art systems. Thus, there is still a need for methods and systems for dispersing combinations of compounds that can provide complete treatment of agricultural products in an efficient process.

### SUMMARY

Aspects of the present application may include a fluid dispersion system having a plurality of side walls defining a confined volume, an agricultural product receiving area configured to hold a volume of agricultural products, a first fogging fan orientated adjacent to the agricultural product receiving area, the first fogging fan having a fluid spraying system configured to spray a fluid compound at high pressure in front of the first fogging fan.

Other aspects of the present application may include a fluid dispersion method. The method may include placing an agricultural product between a plurality of fogging fans in an enclosed environment, spraying an insecticide compound into each of the plurality of fogging fans at high pressure.

### BRIEF DESCRIPTION OF THE DRAWINGS

FIG. 1 illustrates a schematic diagram of a fogging dispersion system configuration in accordance with example implementations of the present application.

FIG. 2 illustrates a photo of fogging fans in accordance with Example implementations of the present application.

FIG. 3 illustrates a schematic diagram of a fogging fan in accordance with example implementations of the present application.

FIGS. 4A and 4B illustrate photos of a fluid pressurization system in accordance with example implementations of the present application.

FIG. 5 illustrates a block diagram representing flow of the compounds from the compound tank to the agricultural products.

FIG. 6 illustrates a flow chart of a process 600 of dispersing or fogging liquid compounds over agricultural products.

### DETAILED DESCRIPTION

The subject matter described herein is taught by way of example implementations. Various details have been omitted for the sake of clarity and to avoid obscuring the subject matter. The examples shown below are directed to structures and processes for applying compounds, typically liquid compounds, to agricultural products through misting, fogging or vaporizing processes.

In order to address issues with existing systems and methods of applying compound to agricultural products, the present applications describes new systems and methods of applying compounds to agricultural products. Additionally, the application also describes new recipes of compounds that may be applied.

In order to maximize efficacy of the application of a compound using fogging, misting, or vaporizing, it may be important to generate droplets that can move easily through the wall. In some example implementations, it has been found that droplet sizes in a range of 5-15 microns in diameter may have sufficient buoyancy to move easily in the air. To obtain these droplet sizes, example implementations of a dispersion system are described below.

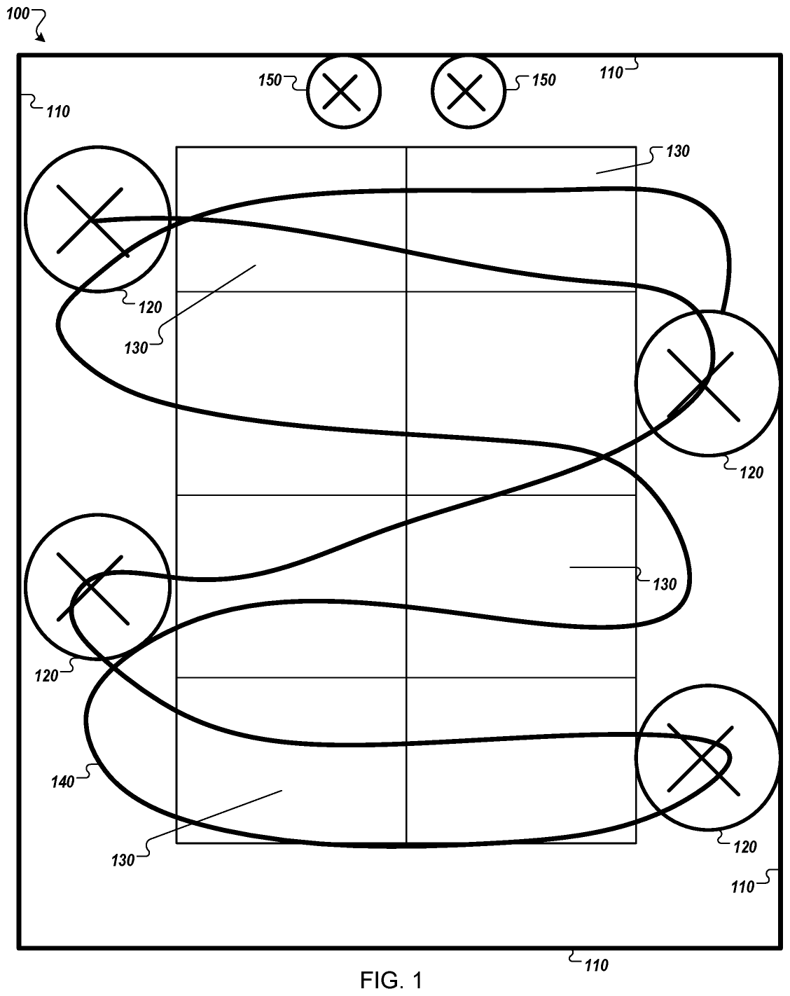

FIG. 1 illustrates a schematic diagram of a fogging dispersion system 100 configuration in accordance with example implementations of the present application. As illustrated, the fogging dispersion system 100 is set up within a confined space defined by 4 sidewalls, a floor and roof (not illustrated). The confined space may be a container wall 110 as shown in FIG. 1. The fogging dispersion system includes a series of fogging fans 120 (described in greater detail below) distributed throughout the confined space around a plurality of storage bins 130 holding the agricultural products (e.g., fruit, such as apples, oranges, etc., veggies, or other agricultural products).

As illustrated, the fogging fans 120 may be arranged in a staggered or offset orientation on opposite sides of the storage bins 130. This configuration may produce a serpentine airflow path (e.g., compound circulation path 140 shown in FIG. 1) such that the air flow of one fogging fan 120 crosses the storage bins 130 and is drawn into an opposite fogging fan 120 and directed back across additional storage bins 130 in the opposite direction. As discussed below, each fogging fan 120 may be fitted with a fluid sprayer having a plurality of spraying heads to inject the compounds into the air flow of each fogging fan 120. This aspect coupled with the arrangement of fogging fans 120 offset on opposite sides of the storage bins 130 may allow the compounds to dispersed, and circulated along the serpentine airflow path 140, while additional compound is injected at each fogging fan 120. Fogging fans are discussed in greater detail below.

The fogging dispersion system 100 may also include one or more circulation fans 150 located at one or both ends of confined space to provide additional circulation and/or cooling to maintain refrigeration conditions.

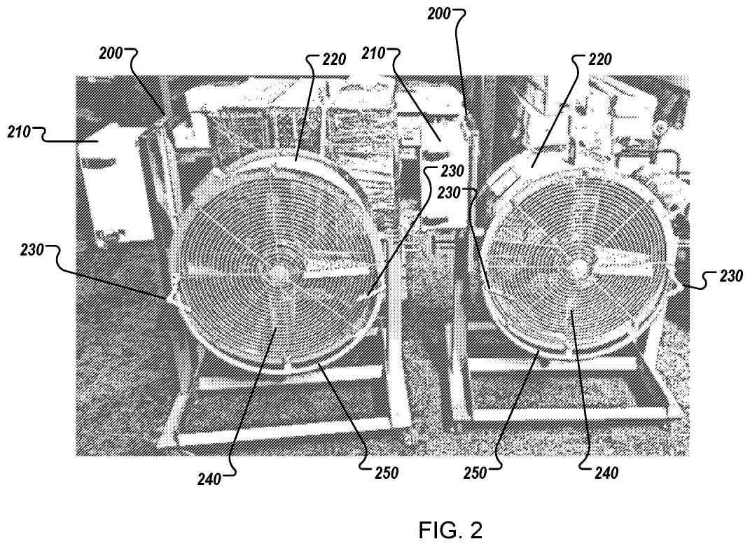

FIG. 2 illustrates a photo of fogging fans in accordance with example implementations of the present application. As illustrated, FIG. 2 illustrates carts 200 with electronics 210 attached thereto. On the carts, fogging fans 220 are provided. Each fan 220 may have one or more sprayer nozzles 230 connected to it. Further, each fan 220 may have fan blades 240 for distributing a liquid emitted from the sprayer nozzles 230. Additionally, a compound supply manifold 250 (discussed in greater detail below) may be provided to each fan 220.

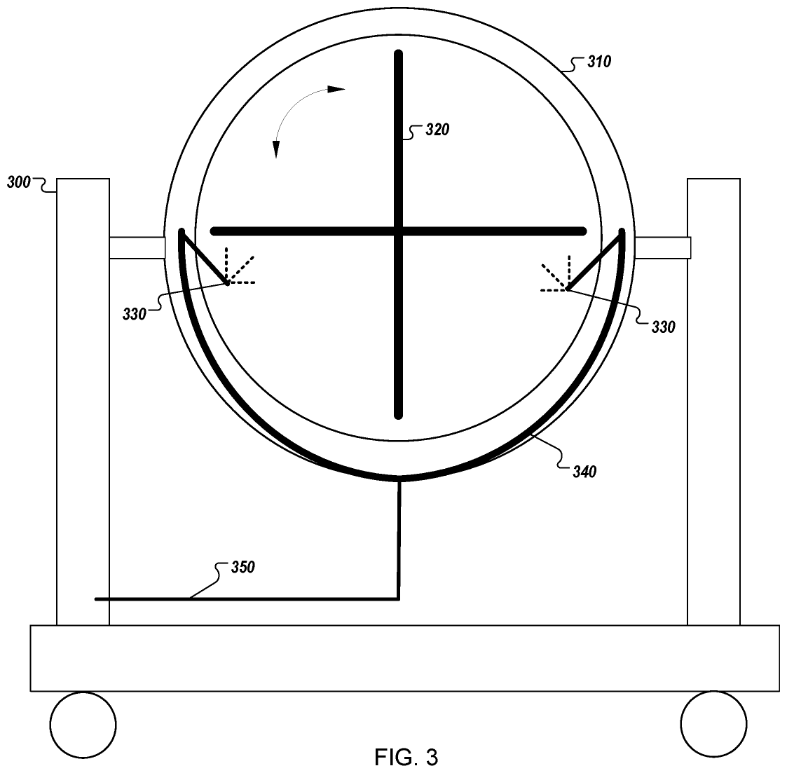

FIG. 3 illustrates a schematic diagram of a fogging fan in accordance with example implementations of the present application. As illustrated, each fogging fan may have a cowling 310 and be mounted on a rolling cart 300 to support or facilitate movement of the fogging fan in some example implementations. The cart 300 may have a rectangular base with one or more wheels attached to allow the base to be moved or positioned. The cart 300 may also provide a mounting position for the electronics that control the fogging fan.

In some example implementations, the fogging fan may be an industrial grade fan capable of producing air flow of up to 8,000 cubic feet per minute (CFM) or more. Additionally, in some example implementations, the fan blades 320 of each fogging fan may be formed from cast metal, such as cast aluminum, to tolerate high air flow rates of 8,000 CFM or more.

In front of each fogging fan a pair of sprayers may be positioned to inject compounds into the air flow created by the rotating fan blades. Each sprayer may be selected to tolerate high pressure spraying and include hydraulic atomizing spray nozzles 330. For example, in some example implementations, the sprayer may be a fine or hollow cone type sprayer (such as TN3 nozzle produced by SPRAYING SYSTEMS). Other types of sprayers may be used if they produce a similar particle size as discussed below. As illustrated, the sprayer nozzles 330 may be located on the front face of the fogging fan at the right and left sides of the fogging fan. For example, the spraying nozzles 330 may be positioned at roughly the 3 o'clock and 9 o'clock positions of the front face of the fogging fan.

The sprayers may be connected to a compound supply manifold 340 that is fluidly coupled to a fluid pressurization system (discussed in greater detail below) by a fan supply line 350. In order the produce a desired particle size (e.g., 5-15 microns), the fluid may be dispersed through the sprayers at pressures greater than 1000 pounds per in² (PSI) in some example implementations. Further, in some example implementations the pressure may be maintained at a rate less than 1250 PSI. Further each nozzle 330 may disperse a volume of 7-8 gallons per hour (for example, 7.5 gallons per hour) for a total of 14-16 gallons per hour (for example, 15 gallons per hour) of compound per fogging fan. However, in other example implementations, a different pressure may be used to obtain the desire particle size based on the sprayer nozzle configuration.

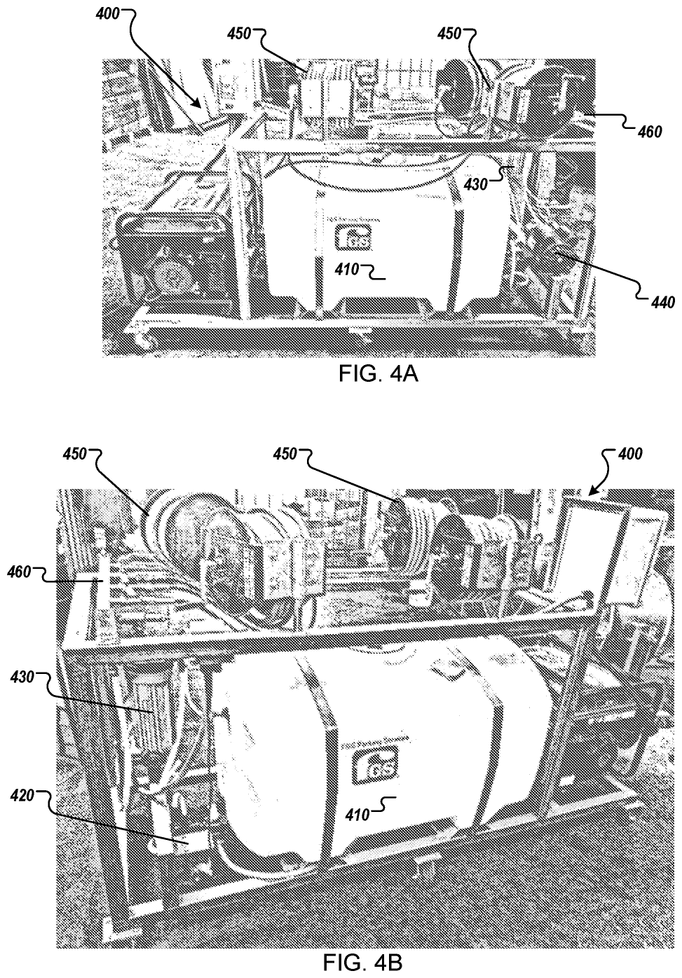

FIGS. 4A and 4B illustrate photos of a fluid pressurization system 400 in accordance with example implementations of the present application. As illustrated, the fluid pressurization system 400 includes a fluid tank 410 which may be filled with one or more compounds that are to be applied to agricultural products. For example, a sanitizer, a fungicide, an insecticide, and/or any other compound or combination of compounds that are to be applied to agricultural products may be used. In some example implementations, the fluid tank 410 may also include an integrated mixer that can mix and ensure consistency of compounds added to the tank.

In some example implementations, a low-pressure pump 420 as shown in FIG. 4B may be connected to the tank 410 to draw the fluid compounds out and pump them through a filtration system 430 to remove any particulates or debris, which may clog or otherwise negatively affect the spray nozzles and manifold. The low-pressure pump 420 is not particularly limited and may have an operating pressure sufficient to draw fluid compounds from the tank 410 at a rate of 3 gallons per minute or more and pump it through the filter. The filter may be sized to filter particle sizes of 75 μm or greater in some example implementations. In other example implementations the filter may be sized to filter particle sizes of 5 μm or greater.

After the compounds are filtered, they are pumped by a high-pressure pump 440 as shown in FIG. 4A through fan supply lines 450 connected to the compound supply manifold illustrated in FIGS. 2 and 3 discussed above. The high-pressure pump 440 may be rated to produce a pressure sufficient that the sprayer nozzles may operate at pressures in a range of 1000 to 1250 PSI. The fan supply lines 450 may be hydraulic hoses rated to withstand at least 6000 psi to avoid rupture failure of the hose during extended operations at the operating pressures preferred to achieve the desired particle size (e.g., 1000-1250 PSI to achieve particle sizes 5 to 15 μm).

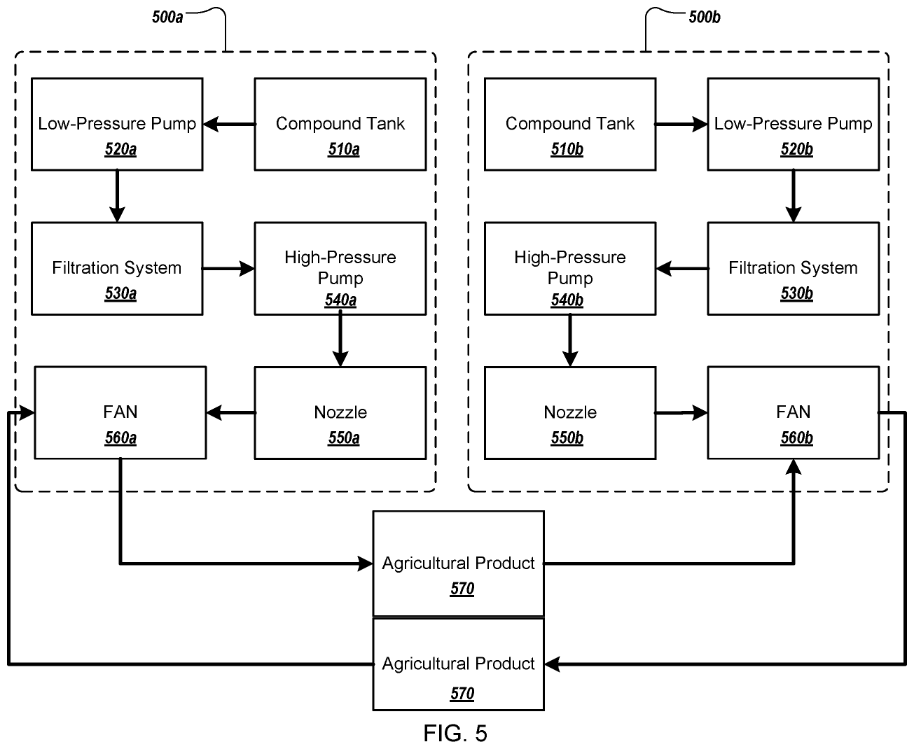

FIG. 5 illustrates a block diagram representing flow of the compounds from the compound tank to the agricultural products. As illustrated, in a first fan system 500a, fluid is drawn out of the compound tank 510a by the low-pressure pump 520a and pushed through the filtration system 530a to the high-pressure pump 540a and out the nozzle 550a which is mounted in front of the fan blades on a first fogging fan 560a as illustrated in FIGS. 2 and 3 discussed above. Similarly as illustrated in a second fan system 500b, fluid is drawn out of the compound tank 510b by another low-pressure pump 520b, pushes through the filtration system 530b to the high-pressure pump 540b, and spray out the nozzles 550b mounted in front of fan blades on a second fogging fan 560b.

Though separate compound tanks, low-pressure pumps, filtration systems, high pressure pumps for each fan system are illustrated in FIG. 5, example implementations do not need to have this configuration. For example, example implementations may also involve a shared compound tank a shared low-pressure pump, a shared filtration system, and a high-pressure pump connected to a distribution manifold 460 (illustrated in FIG. 4), which allows fluids to be provided to multiple fan supply lines, each connected to a separate nozzle mounted on one or more fogging fans.

As illustrated, the fan 560a of the first fan system 500a may push the vaporized fluid over the agricultural product 570 toward the fan 560b of the second fan system 500b, which may then draw the vaporized fluid into its own airstream and push it back over the agricultural product 570. Similarly, the fan 560b of the second fan system 500b may push the vaporized fluid of the agricultural product toward the fan 560a of the first fan system 500a, which may then draw the vaporized fluid into its own airstream and push it back over the agricultural product 570. By circulating and recirculating the vaporized fluid in this manner, efficacy of the compounds may be improved and the volume of compound required to treat agricultural products may be reduced, saving time and money.

These systems illustrated in FIGS. 1-5 may be used to distribute a variety of compounds and are not limited to any particular compound. Some example implementations of recipes of compounds that may be used in for fogging with the illustrated systems are described below. These recipes are provided for example purposes and are not the only compounds which may be used.

Each of these recipes is based on fogging using at least two fans within a closed space arranged in the configuration described above with respect to FIG. 1. Efficacy may be reduced if less than at least two fans are used. Each recipe uses dilution ratios per 100 gallons of water dilution. Additionally, in these recipes though household bleach (5¼%) is illustrated, germicidal bleach (8%) may alternatively be used.

Sanitizer Compounds

Peroxide 1%+Quat 200 ppm
Peroxide 4 gallons per 100 gallons=1%
Quat (disinfectant) ¼ oz per gallon=200 ppm

Sanisol or Citrosol—5 oz per gallon
5 oz per 1 gallons

Borax (20 Mule Team) 0.08%+200 ppm chlorine (5¼% household bleach)
2 boxes of Borax (4 lbs per box; 8 lbs total) to 100 gallons=0.08%
   Chlorine 5¼% household bleach=1,442 mL per 100 gallons

Vinegar 1% (Organic Fleischmann's=12%)
9 gallons per 100 gallons

Quat (disinfectant) 600 ppm (non-porous rate)
¾ oz per gallon (75 oz per 100 gallons)

Fungicide Compounds/Combinations of Fungicides with Organic Acids or Oxidizers

Thiabendazole (TBZ) 200 ppm chlorine (≤90% decay control)
Chlorine 5¼% household bleach=1,442 mL per 100 gallons
TBZ 200 ppm=200 mL per 100 gallons

TBZ 200 ppm/Chlorine/Borax 0.08% (decay control ≤100%)
TBZ=200 mL per 100 gallons
Chlorine 5¼% household bleach=1,442 mL per 100 gallons
Borax (20 Mule Team)=41b box per 100 gallons (0.08%)
3 lbs Citric Acid

Imazalil (IMZ)+¼% Peroxide and/or Peracetic Acid (PAA) 80-100 ppm
IMZ=200 mL per 100 gallons
Peroxide=1 gallon per 100 gallons

IMZ+Citric Acid+Borax+Spray-Aid
IMZ 200 mL per 100 gallons
8 lbs Borox per 100 gallons
3 lbs Citric Acid
200 mL Spray-aid

Fludioxonil 200+200 ppm chlorine (≤80-85% decay control)
Fludioxonil=179 mL per 100 gallons
Chlorine 5¼% household bleach=1,442 mL per 100 gallons

Fludioxonil/200 ppm chlorine/Borax
Fludioxonil=179 mL per 100 gallons
Chlorine 5¼% household bleach=1,442 mL per 100 gallons
Borax (20 Mule Team)=4 lb box per 100 gallons (0.08%)

In some example implementations, these fungicides may also be combined with sodium bicarbonate, potassium sorbate, or sodium propionate on colored fruit.

Adjuvants (Spray-Aid) with all the Fungicides

200 mL Spray-Aid per 100 gallons may also be used with the fungicides in some example implementations.

Insecticides (Such as for Treating Bean Thrips and Other Bugs)

Evergreen (Pyrethrum) insecticide 1:29 dilution (the label specified dilution for treatment of label specified insects).

Alternatively, Evergreen 1:650 dilutions may also be used (a more diluted concentration found to be effective against many insects including Asian Citracilid using the methods described herein).

Additionally, dilutions of 1:900 can also be effective using the methods described herein.

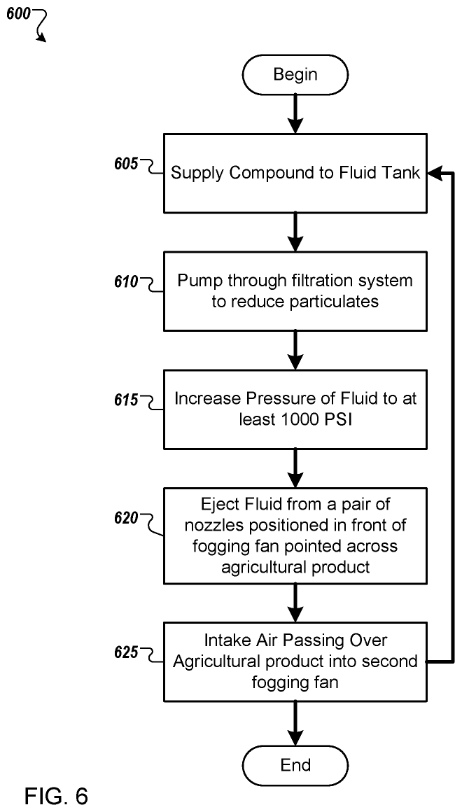

FIG. 6 illustrates a flow chart of a process 600 of dispersing or fogging liquid compounds over agricultural products. This process may be used to disperse disinfectants, fungicides, insecticides, or combinations of any of these chemicals to treat agricultural products for consumption and processing. This process may be used to treat fruits vegetables livestock or really any other agricultural product that may require disinfection, fungicidal treatment, or pest treatment.

In this process, the fluid compound to be dispersed is placed in a fluid tank at 605. In some example implementations the fluid tank may include a mixing system to mix or maintain a constant dispersion of the fluid compounds within the tank. At 610 fluid is pumped from the supply tank to a filtration system to reduce particulates to prevent clogging or mocking of sprayer nozzles and preserve clean flow. After the supplied fluid has been cleaned of particulates it may be pressurized to at least 1000 psi for spraying. In some example implementations, the pressure may be equal to or less than 1250 psi.

After the fluid has been pressurized, it is ejected through a pair of nozzles positioned on opposite sides of the outlet face of a fogging fan to be blown and dispersed across an agricultural product at 620. In some example implementations, the fighting fans may be high-volume industrial fans capable of producing at least 8000 ft.³ per minute of airflow.

After the air containing the dispersed compounds passes over the agricultural product, it is taken up by a second fogging fan at 625 and the process returns to 620, where additional pressurized fluid is ejected from a pair of nozzles positioned in front of the outlet face of the second fogging fan. 620 and 625 may be repeated between two or more fogging fans to circulate and recirculate air containing dispersed compounds around and through the agricultural products for a period of time sufficient to complete the necessary treatment. By ejecting the fluid at the pressure between 1000 and 1250 psi in front of fogging fans producing airflow of 8000 ft³ per minute, the particle size of the ejected fluid has been found to be between 5 and 15 μm and remain dispersed in the airflow for an extended period of time. This produces high efficacy of the treatments.

For example, experiments using this process used to apply insecticides have been shown to be between 95 and 99% effective in eliminating pests during a 1-3 hour time frame. Further, in one experiment only 3 insects out of 2500 insects placed through 48 bins of produce were found to have survived a 1-3 treatment process. Further, the process can be used for a 14 hour time frame to sanitize and remove fungus from a storage room.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

We claim:

1. A fluid dispersion system comprising:
a plurality of side walls defining a confined volume;
an agricultural product receiving area configured to hold a volume of agricultural products;
a first fogging fan orientated adjacent to the agricultural product receiving area, the first fogging fan having a fluid spraying system configured to spray a fluid compound at high pressure in front of the first fogging fan.

2. The fluid dispersion system of claim 1, further comprising a second fogging fan oriented adjacent to the agricultural product receiving area on a side of the agricultural product receiving area opposite from the first fogging fan wherein the second fogging fan includes a fluid spraying system configured to spray the fluid compound at high pressure in front of the second fogging fan.

3. The fluid dispersion system of claim 2, wherein second fogging fan is positioned to intake an airflow from the first fogging fan containing the sprayed fluid compound and redirect it toward the agricultural product with additional fluid compound sprayed in front of the second fogging fan.

4. The fluid dispersion system of claim 3, wherein the fluid spraying system of the first fogging fan includes at least two spraying nozzles positioned in front of the first fogging fan and oriented to spray the fluid compound at high pressure in front of the first fogging fan; and
wherein the fluid spraying system of the second fogging fan includes at least two spraying nozzles positioned in front of the second fogging fan and oriented to spray the fluid compound at high pressure in front of the second fogging fan.

5. The fluid dispersion system of claim 4, wherein a first spraying nozzle of the at least two spraying nozzles is located to on a right side of an outlet face of each of the first fogging fan and the second fogging fan; and
wherein a second spraying nozzle of the at least two spraying nozzles is located to on a left side of the outlet face of each of the first fogging fan and the second fogging fan

6. The fluid dispersion system of claim 5, wherein the at least two spraying nozzles of the first fogging fan are connected by a compound supply manifold; and
the at least two spraying nozzles of the second fogging fan are connected by a compound supply manifold.

7. The fluid dispersion system of claim 6, wherein the compound supply manifold of the first fogging fan is connected to a fluid supply line providing the fluid compound at high pressure; and
wherein the compound supply manifold of the second fogging fan is connected to a fluid supply line providing the fluid compound at high pressure.

8. The fluid dispersion system of claim 7, wherein the fluid supply line of the first fogging fan and the fluid supply line of the first fogging fan are connected to a high pressure fluid supply system.

9. The fluid dispersion system of claim 8, wherein the high pressure fluid supply system provides the compound fluid at a pressure between 1000 and 1250 psi.

10. A method of removing insects from an agricultural product comprising:
placing an agricultural product between a plurality of fogging fans in an enclosed environment;
spraying an insecticide compound into each of the plurality of fogging fans at high pressure.

11. The method of claim 10, wherein the plurality of fogging fans are positioned on opposite sides of the agricultural products in a configuration such that an airflow from a first fogging fan containing the sprayed fluid compound is taken in by a second fogging fan and redirected toward the agricultural product with additional fluid compound sprayed in front of the second fogging fan.

12. The method of claim 11, wherein the insecticide is sprayed at a pressure between 1000 and 1250 psi.

13. The method of claim 12, wherein the insecticide is Evergreen (Pyrethrum) insecticide with a 1:29 dilution ratio.

14. A method of removing fungus from an agricultural product comprising:
placing an agricultural product between a plurality of fogging fans in an enclosed environment;
spraying an fungicide compound into each of the plurality of fogging fans at high pressure.

15. The method of claim 10, wherein the plurality of fogging fans are positioned on opposite sides of the agricultural products in a configuration such that an airflow from a first fogging fan containing the sprayed fluid compound is taken in by a second fogging fan and redirected toward the agricultural product with additional fluid compound sprayed in front of the second fogging fan.

16. The method of claim 11, wherein the fungicide is sprayed at a pressure between 1000 and 1250 psi.

17. The method of claim 12, wherein the fungicide is one or more of:
Tiabendazole (TBZ) 200 ppm chlorine;
TBZ 200 ppm/chlorine/Borax 0.08%;
Imazalil (IMZ)+¼% Peroxide and/or Peracetic Acid (PAA) 80-100 ppm;
IMZ+Citric Acid+Borax+Spray-Aid;
Fludioxonil 200+200 ppm chlorine; and
Fludioxonil/200 ppm chlorine/Borax.
